(19) United States
(12) Patent Application Publication
(10) Pub. No.: US 2008/0233305 A1
(43) Pub. Date: Sep. 25, 2008

(54) Method for manufacturing coating film

(75) Inventor: Kazuko Murata, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 12/077,438

(22) Filed: Mar. 18, 2008

(30) Foreign Application Priority Data
Mar. 22, 2007 (JP) 2007-074556

(51) Int. Cl. B05D 3/06; C08F 2/48

(52) U.S. Cl. 427/492

(57) ABSTRACT

A method for manufacturing a coating film having a coating layer on a transparent base material. The method includes a step of forming a coated film by coating a coating liquid having a material for forming a coating layer that is curable by ultraviolet radiation on the transparent base material, and a step of irradiating the coated film composed by the coating liquid and formed on the transparent base material with pulsed ultraviolet radiation to form the coating layer.

### CROSS REFERENCE

This application claims priority to Japanese application number 2007-074556, filed on Mar. 22, 2007, which is incorporated by reference.

### BACKGROUND OF THE INVENTION

1. Field of the Invention

The present invention relates to a coating film in which a coating layer is provided on a transparent base material. The coating film in accordance with the present invention can be advantageously used for a surface protective film for touch panels or glass of displays such as liquid crystal display (LCD) devices, cathode ray tube (CRT) display devices, plasma display panels (PDP), and field emission displays (FED), and also for consumer electronics products.

2. Description of the Related Art

It has been suggested to produce a polarizing plate and protect the surface of the polarizing plate that is on the display surface by using a coating film in which a coating layer is formed on a transparent base material film composed of a plastic film on the surface of various displays, for example, liquid crystal display (LCD) devices.

High hardness and scratch resistance are required for the coating layer provided in the coating film, and the hard coating layer is formed by using a material curable by ionizing radiation as a material for forming the coating layer, coating a coating liquid containing the material curable by ionizing radiation on a transparent base material, and irradiating with ionizing radiation

### SUMMARY OF THE INVENTION

A material curable by ultraviolet radiation can be used as the material curable by ionizing radiation, and the coating layer can be formed by irradiating a coating film containing such material with ultraviolet radiation. When a coating film is formed by irradiating a coating film composed of a coating layer present on a transparent base material with ultraviolet radiation, the manufactured coating film is curled due to wrinkles in the transparent base material caused by the energy of ultraviolet radiation or shrinkage occurring when the coating layer is cured.

The manufactured coating film is joined to other components and provided on the display surface. The problem associated with wrinkled or curled coating films is that defects easily occur in subsequent processing, for example, when the film is joined to other components in the joining process. Therefore, a coating film is needed in which the coating layer has not only a sufficient surface hardness, but also very little wrinkling and curling.

It is an object of the present invention to provide a coating film that has a sufficient surface hardness, no wrinkles, and little curling.

### BRIEF DESCRIPTION OF THE DRAWINGS

FIG. 1 is an explanatory cross-sectional view of the coating film in accordance with the present invention.

FIG. 2 is an explanatory cross-sectional view of the coating film of another embodiment of the present invention.

FIG. 3 is an explanatory cross-sectional view of the coating film of another embodiment of the present invention.

### DESCRIPTION OF THE PREFERRED EMBODIMENTS

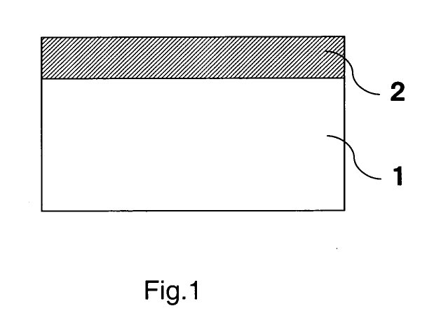

FIG. 1 is an explanatory cross-sectional view of the coating film in accordance with the present invention.

In the coating film in accordance with the present invention that is shown in FIG. 1, a coating layer 2 is laminated on a transparent base material 1. In the coating film in accordance with the present invention, the coating layer has a sufficient surface hardness, and the film can be advantageously used for a display surface. The coating film in accordance with the present invention may be also provided with functional layers that demonstrate antireflection ability, antistatic ability, anti-fouling ability, antiglare property, electromagnetic shielding ability, infrared radiation absorption ability, ultraviolet radiation absorption ability, color correction ability, and the like, on the coating layer. Examples of such functional layers include antireflective layers, antistatic layers, antifouling layers, antiglare layers, electromagnetic shielding layers, infrared-absorbing layers, ultraviolet-absorbing layers, and color correcting layers. These functional layers may me provided individually, or a plurality of such layers may be provided. For example, the antireflective layer may be composed of a single layer with a low refractive index or of a plurality of layers obtained by lamination of layers with a low refractive index and layers with a high refractive index. Further, one functional layer may have a plurality of functions. For example, an antireflective layer may additionally have anti-fouling property.

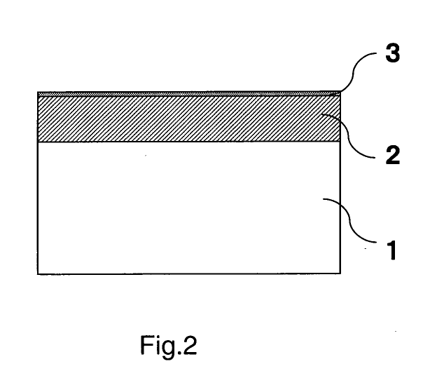

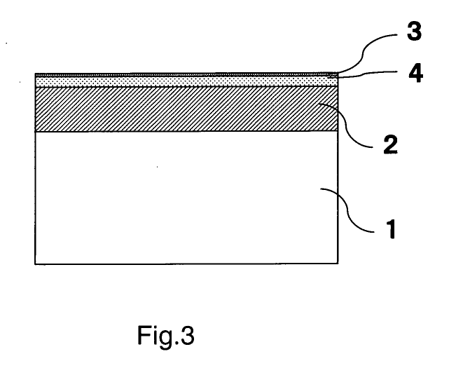

FIG. 2 is an explanatory cross-sectional view of the coating film of another embodiment of the present invention. In the coating film in accordance with the present invention that is shown in FIG. 2, a coating layer 2 and an antireflective layer 3 are successively laminated on a transparent base material 1. In this configuration, the antireflective layer may be composed of a single layer with a low refractive index or of a plurality of layers obtained by lamination of layers with a low refractive index and layers with a high refractive index. By providing the antireflective layer on the coating layer, it is possible to obtain a coating film that has an antireflection ability preventing the reflection of external light. Further, FIG. 3 is an explanatory cross-sectional view of the coating film of another embodiment of the present invention. In the coating film in accordance with the present invention that is shown in FIG. 3, a coating layer 2, an antistatic layer 4, and an antireflective layer 3 are successively laminated on a transparent base material 1. By laminating the antistatic layer and antireflective layer on the coating layer, it is possible to obtain a coating film that has both the antireflection ability and the antistatic ability.

A method for manufacturing the coating film in accordance with the present invention will be described below. The manufacturing method in accordance with the present invention comprises the steps of forming a coated film by coating a coating liquid comprising a material for forming a coating layer that includes an urethane (meth)acrylate material and can be cured by ultraviolet radiation on a transparent base material, and forming the coating layer by irradiating the coated film composed of the coating liquid and formed on the transparent base material with pulsed ultraviolet radiation.

The inventor has discovered that a coating film with little curling can be manufactured by irradiating with pulsed ultraviolet radiation in the process of forming a coating layer by irradiating a coated film composed of a coating liquid on a transparent base material with ultraviolet radiation. This finding led to the creation of the present invention.

High-pressure mercury lamp systems and electrodeless lamp systems are usually used as lamp systems for curing the materials curable with ultraviolet radiation. High-pressure mercury lamp systems have a main wavelength at 365 nm and emit ultraviolet radiation with a wavelength of 254 nm, 303 nm, and 313 nm with high efficiency. A specific feature of such lamp systems is that because the input (W) is higher, the irradiance is also high. In electrodeless lamp systems, a light-emitting substance located inside the lamp bulb is excited by microwave energy to obtain plasma and make a conversion into light energy. A specific feature of such lamp systems is that because no electrodes are present, the lamp has high light stability, low level of heating, and long service life.

However, when a coated film composed of a coating liquid located on a transparent base material is cured by using a high-pressure mercury lamp or an electrodeless lamp, large curls appear in the manufactured coating film. In particular, this trend is manifested when triacetyl cellulose is used as the transparent base material.

The inventor has discovered that a coating film with little curling can be obtained by curing a coated film composed of a coating liquid with pulsed ultraviolet radiation, and this finding led to the creation of the present invention. A xenon flash lamp or a pulsed xenon lamp can be used as means for irradiating with pulsed ultraviolet radiation.

Xenon flash lamp systems and pulsed xenon lamp systems produce continuous light emission from a UV range to an IR (infrared) range, and pulsed light emission with a half-width of about 100 μsec can be obtained. Thus, the coated film can be irradiated with pulsed light by using a xenon flash lamp or a pulsed xenon lamp.

The energy of these xenon flash lamp and pulsed xenon lamp is preferably 500 J or more to 150 J or less, more preferably 50 J or more to 120 J or less. The number of shots is preferably 4 or more to 10 or less, more preferably 4 or more to 7 or less.

Where the energy of xenon flash lamp and pulsed xenon lamp is less than 50 J, the coated film present on the transparent base material cannot be fully cured, and the obtained coating layer sometimes cannot have a sufficient surface hardness. Further, when the energy of xenon flash lamp and pulsed xenon lamp is more than 150 J, curls sometimes occur. Where the number of shots of xenon flash lamp and pulsed xenon lamp is 3 or less, the obtained coating layer sometimes cannot have a sufficient surface hardness. Where the number of shots of xenon flash lamp and pulsed xenon lamp is 10 or more, curls sometimes occur.

An urethane (meth)acrylate oligomers can be preferably used as the material curable with ultraviolet radiation in the coating liquid containing the material for forming the coating layer that is curable with ultraviolet radiation and used in accordance with the present invention. By using an urethane (meth)acrylate oligomer as the material for forming the coating layer, it is possible to obtain a coating layer that has a sufficient surface hardness, has characteristic features of urethane resins such as flexibility and rubber elasticity, and excels in ability to move on with the film base material and bendability.

It is preferred that an urethane (meth)acrylate oligomer with a weight-average molecular weight of 1000-10,000, more preferably an urethane (meth)acrylate oligomer with a weight-average molecular weight of 1200-8000 be used as the urethane (meth)acrylate oligomers. Where an urethane (meth)acrylate oligomer with a weight-average molecular weight of 1000 or less is used, the degree of curing-induced shrinkage can be high and the degree of curing of the coating film after curing sometimes increases. On the other hand, when an urethane (meth)acrylate oligomer with a weight-average molecular weight of 10000 or more is used, a coating liquid is sometimes difficult to obtain by dissolving or dispersing the urethane (meth)acrylate material in a solvent.

Urethane (meth)acrylates are obtained by reacting a polyhydric alcohol, a polyhydric isocyanate, and an acrylate containing a hydroxyl group. More specifically, for example, urethane (meth)acrylates UA-306H, UA-306T, and UA-306I manufactured by Kyoeisha Chemical Co., Ltd., UV-1700B, UV-6300B, UV-7600B, UV-7605B, UV-7640B, and UV-7650V manufactured by Nippon Gosei Kagaku Co., Ltd., U-4HA, U-6HA, UA-100H, U-6LPA, U-15HA, UA-32P, and U-324A manufactured Shin-Nakamura Kagaku Kogyo K.K., Ebecryl-1290, Ebecryl-1290K, and Ebecryl-5129 manufactured by Daicel-UCB Co., Ltd., and UN-3220HA, UN-3220HB, UN-3220HC, and UN-3220HS manufactured by Negami Kogyo K.K. can be used.

In accordance with the present invention, the urethane (meth)acrylate oligomer is preferably contained in an amount of 25 parts by weight or more to 100 parts by weight or less per 100 parts by weight of the material for forming the coating layer. Where the amount of the urethane (meth)acrylate oligomer is less than 25 parts by weight, a coating film having a coating layer that has a sufficient surface hardness and excels in ability to move on with the film base material and bendability sometimes cannot be obtained.

In addition to the urethane (meth)acrylate oligomer, a compound having a radical-polymerizable unsaturated double bond can be also used as the material for forming the coating layer. A material for forming the coating layer can be also obtained by introducing a compound having a radical-polymerizable unsaturated double bond within the above-described range into an urethane acrylate oligomer. Examples of compounds having a radical-polymerizable unsaturated double bond include (meth)acrylates other than urethane (meth)acrylates and vinyl ether compounds.

Examples of the aforementioned (meth)acrylates include monofunctional (meth)acrylates, bifunctional (meth)acrylates, and (meth)acrylates with a functionality of three or more. When monofunctional (meth)acrylates and bifunctional (meth)acrylates are used, the coating layer excels in ability to move on with the plastic film and bendability. Accordingly, such (meth)acrylates are preferred.

Examples of monofunctional (meth)acrylates include 2-hydroxyethyl(meth)acrylate, 2-hydroxypropyl(meth)acrylate, 2-hydroxybutyl(meth)acrylate, n-butyl(meth)acrylate, isobutyl (meth)acrylate, t-butyl(meth)acrylate, glycidyl(meth)acrylate, acryloyl morpholine, N-vinyl pyrrolidone, tetrahydrofurfuryl acrylate, cyclohexyl(meth)acrylate, 2-ethylhexyl(meth)acrylate, isobornyl(meth)acrylate, isodecyl(meth)acrylate, lauryl (meth)acrylate, tridecyl(meth)acrylate, cetyl(meth)acrylate, stearyl(meth)acrylate, benzyl(meth)acrylate, 2-ethoxyethyl (meth)acrylate, 3-methoxybutyl(meth)acrylate, ethyl carbytol (meth)acrylate, phosphoric acid (meth)acrylate, ethylene oxide-modified phosphoric acid (meth)acrylate,

phenoxy(meth)acrylate, ethylene oxide-modified phenoxy (meth)acrylate, propylene oxide-modified phenoxy(meth)acrylate, nonylphenol (meth)acrylate, ethylene oxide-modified nonylphenol (meth)acrylate, propylene oxide-modified nonylphenol (meth)acrylate, methoxydiethylene glycol (meth)acrylate, methoxypolyethylene glycol (meth)acrylate, methoxypropylene glycol (meth)acrylate, 2-(meth)acryloyloxyethyl-2-hydroxypropyl phthalate, 2-hydroxy-3-phenoxypropyl(meth)acrylate, 2-(meth)acryloyloxyethyl hydrogen phthalate, 2-(meth)acryloyloxypropyl hydrogen phthalate, 2-(meth)acryloyloxypropyl hexahydrohydrogen phthalate, 2-(meth)acryloyloxypropyl tetrahydrohydrogen phthalate, dimethylaminoethyl(meth)acrylate, trifluoroethyl(meth)acrylate, tetrafluoropropyl(meth)acrylate, hexafluoropropyl(meth)acrylate, octafluoropropyl(meth)acrylate, octafluoropropyl(meth)acrylate, and adamantane derivative mono(meth)acrylates such as adamantyl acrylate having a monovalent mono(meth)acrylate derived from 2-adamantane and adamantane diol.

Examples of difunctional (meth)acrylates include di(meth)acrylates such as ethylene glycol di(meth)acrylate, diethylene glycol di(meth)acrylate, butanediol di(meth)acrylate, hexanediol di(meth)acrylate, nonanediol di(meth)acrylate, ethoxyhexanediol di(meth)acrylate, propoxyhexanediol di(meth)acrylate, diethylene glycol di(meth)acrylate, polyethylene glycol di(meth)acrylate, tripropylene glycol di(meth)acrylate, polypropylene glycol di(meth)acrylate, neopentylglycol di(meth)acrylate, ethoxyneopentyl glycol di(meth)acrylate, tripropylene glycol di(meth)acrylate, and hydroxypyvalic acid neopentyl glycol di(meth)acrylate.

Examples of (meth)acrylates having a functionality of three or more include tri(meth)acrylates such as trimethylolpropane tri(meth)acrylate, ethoxytrimethylolpropane tri(meth)acrylate, propoxytrimethylolpropane tri(meth)acrylate, tris-2-hydroxyethyl isocyanurate tri(meth)acrylate, and glycerin tri(meth)acrylate, (meth)acrylate compounds having a functionality of three or more such as pentaerythritol tri(meth)acrylate, dipentaerythritol tri(meth)acrylate, and ditrimethylolpropane tri(meth)acrylate, polyfunctional (meth)acrylates having a functionality of three or more such as pentaerythritol tetra(meth)acrylate, ditrimethylolpropane tetra(meth)acrylate, dipentaerythritol tetra(meth)acrylate, dipentaerythritol penta(meth)acrylate, ditrimethylolpropane penta(meth)acrylate, dipentaerythritol hexa(meth)acrylate, and ditrimethylolpropane hexa(meth)acrylate, and polyfunctional (meth)acrylates obtained by substituting part of the aforementioned (meth)acrylates with an alkyl group or ε-caprolactone.

Further, in accordance with the present invention, a photopolymerization initiator can be added, if necessary, to the coating liquid. A variety of photopolymerization initiators can be used in accordance with the present invention. Examples of suitable ones include compounds of a type that generate radicals by hydrogen attraction, such as benzophenones, benzyl, Michler's ketone, thioxanthone, and anthraquinone. These compounds are used together with tertiary amines such as methylamine, diethanolamine, N-methyldiethanolamine, and tributylamine.

Photopolymerization initiators of other types include compounds in which radicals are generated by intramolecular splitting. Specific examples of such compounds include benzoyl, dialkoxyacetophenone, acyloxime ester, benzylketal, hydroxyalkylphenone, and halogenoketones.

Further, if necessary, a polymerization inhibitor such as hydroquinone, benzoquinone, toluhydroquinone, and paratertiary butyl catechol can be added together with the photopolymerization initiator.

In accordance with the present invention, additives such as antioxidants, ultraviolet absorbers, leveling agents, surfactants, antislip agents, and antifoaming agents may be added, if necessary, to the coating liquid.

By introducing particles with a size of 0.5 μm or more to 10 μm or less into the coating liquid in accordance with the present invention, peaks and valleys can be formed on the surface of the obtained coating layer, and the coating film can be imparted with antiglare property. In this case, it is preferred that the particles have light transparency. Specific examples of suitable particles include acrylic particles, PMMA particles, acrylstyrene particles, PMMA styrene particles, polystyrene particles, polycarbonate particles, melamine particles, epoxy particles, polyurethane particles, Nylon particles, polyethylene particles, polypropylene particles, silicone particles, polytetrafluoroethylene particles, polyvinylidene fluoride particles, poly(vinyl chloride) particles, poly(vinylidene chloride) particles, glass particles, and silica particles. Particles of a plurality of kinds can be also used.

If necessary, the material for forming the coating can be dissolved or dispersed in a solvent to form the coating liquid in accordance with the present invention. Examples of suitable solvents include toluene, cyclohexanone, acetone, ketones, ethyl cellosolve, ethyl acetate, butyl acetate, methyl isobutyl ketone, isopropanol, methyl ethyl ketone, cyclohexanone, 2-butanone, tetrahydrofuran, nitromethane, 1,4-dioxane, dioxolane, N-methylpyrrolidone, methyl acetate, ethyl acetate, butyl acetate, dichloromethane, trichloromethane, trichloroethylene, ethylene chloride, trichloroethane, tetrachloroethane, N,N-dimethylformamide, and chloroform. Mixtures of these solvents can be also used. The amount of the solvent is not particularly limited.

Glass and plastic films can be used as the transparent base material employed in accordance with the present invention. Any plastic film may used, provided that it has appropriate transparency and mechanical strength. Suitable examples include films of polyethylene terephthalate (PET), triacetyl cellulose (TAC), diacetyl cellulose, acetyl cellulose butyrate, polyethylene naphthalate (PEN), cycloolefin polymers, polyimides, polyethersulfones (PES), polymethyl methacrylate (PMMA), and polycarbonates (PC). Among them, when the coating film is used for the front surface of a liquid crystal display device, triacetyl cellulose (TAC) is especially preferred because it has no optical anisotropy.

In the manufacture of the coating film in accordance with the present invention, the coating liquid is coated at least on one surface of the transparent base material by a wet coating method and a coated film is formed on the transparent base materials.

Examples of suitable wet coating methods include a dip coating method, a spin coating method, a flow coating method, a spray coating method, a roll coating method, a gravure roll coating method, an air doctor coating method, a blade coating method, a wire doctor coating method, a knife coating method, a reverse coating method, a transfer roll coating method, a microgravure coating method, a kiss coating method, a cast coating method, a slot orifice coating method, a calendar coating method, and a die coating method.

The coated film on the transparent base material that is formed by coating the coating liquid is irradiated with pulsed ultraviolet radiation in order to cure the coated film and obtain a coating layer. In this case, a drying process for removing the solvent contained in the coating liquid may be performed before irradiating with pulsed ultraviolet radiation. Examples of suitable drying means include heating, air blowing, and hot air blowing.

A xenon flash lamp and a pulsed xenon lamp can be used, as has been indicated hereinabove, as means for irradiating the coated film on the transparent base material with pulsed ultraviolet radiation.

In accordance with the present invention, the thickness of the coating layer after irradiation with ultraviolet radiation is preferably 5 μm or more to 20 μm or less. Where the thickness of coating layer is more than 20 μm, the coated film on the transparent base material sometimes cannot be cured efficiently with the pulsed ultraviolet radiation. Where the coating layer thickness is less than 5 μm, a coating layer with a sufficient surface hardness sometime cannot be obtained. Further, the thickness of the wet coated film immediately after the coating liquid has been charged onto the transparent base material is preferably 5 μm to 30 μm.

The coating film in accordance with the present invention is formed as described above. A method for forming an antireflective layer as a functional layer provided on the coating layer in the coating film in accordance with the present invention will be described below.

Examples of antireflective layers provided as functional layers on the coating layer include an antireflective layer of a laminated structure in which layers with a high refractive index and layers with a low refractive index are stacked repeatedly and an antireflective layer of a monolayer structure composed of a single layer having a low refractive index. Further, examples of methods for forming the antireflective layer include vacuum film forming methods such as a vacuum vapor deposition method, a sputtering method or a CVD method and a wet film forming method by which a coating liquid for forming the antireflective layer is coated on the coating layer surface.

A method by which a coating liquid for forming a layer with a low refractive index is coated on the coating layer surface and a monolayer with a low refractive index is formed as an antireflective layer by a wet film forming method will be described below. The thickness (d) of the monolayer with a low refractive index that is the antireflective layer is so designed that the optional film thickness (nd) obtained by multiplying the film thickness (d) by the refractive index (n) of the layer with a low refractive index is equal to ¼ of the visible light wavelength. A material obtained by dispersing low-refractive particles in a binder matrix can be used for the layer with a low refractive index.

Particles with a low refractive index that are composed of a low-refractive material such as magnesium fluoride or calcium fluoride can be used as the low-refractive particles. Further, particles having internal cavities can be advantageously used as the particles with a low refractive index. In the particles having internal cavities, the cavity portions can have a refractive index (about 1) of air. Therefore, low-refractive particles that impart an extremely low refractive index can be obtained. More specifically, low-refractive silica particles having internal cavities can be used.

On the other hand, a polyfunctional acrylate such as an acrylic acid or methacrylic acid ester of a polyhydric alcohol and polyfunctional urethane acrylates such that are synthesized from diisocyanates, polyhydric alcohols, and acrylic acid or methacrylic acid hydroxyl esters, these material being curable by ionizing radiation, can be used for forming the binder matrix. In addition, polyether resins having functional groups of acrylate system, polyester resins, epoxy resins, alkyd resins, spyroacetal resins, polybutadiene resins, and polythiolpolyene resins can be also used as the materials curable by ionizing radiation. When such materials curable by ionizing radiation are used, the binder matrix is formed by irradiation with ionizing radiation such as ultraviolet radiation or electron beams. Further, metal alkoxides, for example, silicon alkoxides such as tetramethoxysilane and tetraethoxysilane can be used as the materials for forming the binder matrix. In this case, the binder matrix based on silicon oxide, which is a metal oxide, can be obtained by hydrolysis and dehydration condensation.

A coating liquid for forming a layer with a low refractive index that contains the material with a low refractive index and the material for forming the binder matrix is coated on the coating of the hard coating layer. If necessary a solvent or a variety of additives can be added to the coating liquid for forming a layer with a low refractive index. The solvent can be appropriately selected, with consideration for suitability for coating, from aromatic hydrocarbons such as toluene, xylene, cyclohexane, and cyclohexylbenzene, hydrocarbons such as n-hexane, ethers such as dibutyl ether, dimethoxymethane, dimethoxyethane, diethoxyethane, propylene oxide, dioxane, dioxolane, trioxane, tetrahydrofuran, anisol, and phenetol, ketones such as methyl isobutyl ketone, methyl butyl ketone, acetone, methyl ethyl ketone, diethyl ketone, dipropyl ketone, diisobutyl ketone, cyclopentanone, cyclohexanone, 2-methyl cyclohexanone, and 4-methyl cyclohexanenone, esters such as ethyl formate, propyl formate, n-pentyl formate, methyl acetate, ethyl acetate, methyl propionate, ethyl propionate, n-pentyl acetate, and γ-butyrolactone, cellosolves such as methyl cellosolve, cellosolve, butyl cellosolve, and cellosolve acetate, alcohols such as methanol, ethanol, and isopropyl alcohol, and water. Further, surface modificators, antistatic agents, contamination preventing agents, water repellants, agents adjusting the refractive index, adhesion enhancers, and curing agents can be added as the additives.

Examples of suitable coating methods include a dip coating method, a spin coating method, a flow coating method, a spray coating method, a roll coating method, a gravure roll coating method, an air doctor coating method, a blade coating method, a wire doctor coating method, a knife coating method, a reverse coating method, a transfer roll coating method, a microgravure coating method, a kiss coating method, a cast coating method, a slot orifice coating method, a calendar coating method, and a die coating method.

When the material curable by ionizing radiation is used as the material for forming the binder matrix in the coated film obtained by coating the coating liquid on the coating layer, the layer with a low refractive index is formed by irradiation with ionizing radiation after optional drying of the coated film has been conducted. When a metal alkoxide is used as the material for forming the binder matrix, the layer with a low refractive index is formed by a heating process such as drying and heating.

A process in which an antireflective layer composed of a repeated structure of layers with a low refractive index and layers with a high refractive index is formed by a vacuum film forming method will be described below. For example, a two-layer structure including a layer with a high refractive index and a layer with a low refractive index and a four-layer structure including a layer with a high refractive index, a layer with a low refractive index, a layer with a high refractive index, and a layer with a low refractive index formed in the order of description from the side of the hard coat layer can be used as the antireflective layer having a repeated structure of layers with a low refractive index and layers with a high refractive index.

In this case, examples of suitable materials for forming the layer with a high refractive index include metals such as indium, tin, titanium, silicon, zinc, zirconium, niobium, magnesium, bismuth, cerium, tantalum, aluminum, germanium, potassium, antimony, neodymium, lanthanum, thorium, and hafnium, alloys containing two or more such metals, and oxides, fluorides, sulfides, and nitrides thereof. More specific examples include metal oxides such as titanium oxide, niobium oxide, zirconium oxide, tantalum oxide, zinc oxide, indium oxide, cerium oxide, and indium tin oxide. Further, when a plurality of layers with a high refractive index are laminated, it is not necessary to select identical materials and the materials can be appropriately selected according to the object.

Examples of suitable materials for forming the layer with a low refractive index include silicon oxide, titanium nitride, magnesium fluoride, barium fluoride, calcium fluoride, hafnium fluoride, and lanthanum fluoride, but this list is not limiting. Furthermore, in the case a plurality of layers are laminated, it is not necessary to select identical materials and the materials can be appropriately selected according to the object. In particular silicon oxide, which is a metal oxide, is an optimum material from the standpoint of optical properties, mechanical strength, cost, and suitability for film formation.

An antireflective layer can be formed by successively forming the films of these materials with a high refractive index and materials with a low refractive index by a vacuum film forming method. Examples of vacuum film forming methods include a vacuum deposition method, an ion plating method, and ion beam assist method, a sputtering method, and a CVD method. In the antireflective layer, a layer with an intermediate refractive index may be provided between the layer with a high refractive index and the layer with a low refractive index.

When an antistatic layer is provided as a functional layer, a metal oxide such as zinc oxide, indium oxide, and indium tin oxide is formed by a vacuum film forming method. Further, an antistatic layer in which conductive metal oxide particles are dispersed in a binder matrix can be formed by coating a coating liquid for forming an antistatic layer that contains conductive metal oxide particles such as zinc oxide, indium oxide, and indium tin oxide and a material for forming a binder matrix onto the coating layer and, if necessary, performing irradiation with ionizing radiation and heating.

Prior to forming a functional layer on the coating layer, a surface treatment such as acid treatment, alkali treatment, corona treatment, and atmospheric pressure glow discharge plasma treatment may be performed. By performing such surface treatment, it is possible to improve adhesion between the coating layer and functional layer.

Prior to forming the functional layers, that is, the antireflective layer and antistatic layer, on the coating layer, a surface treatment such as acid treatment, alkali treatment, corona treatment, and atmospheric pressure glow discharge plasma treatment may be performed. By performing such surface treatment, it is possible to improve adhesion between the coating layer and functional layer.

When a metal alkoxide such as silicon alkoxide is used as a material for forming the binder matrix and the antireflective layer or antistatic layer is formed on the coating layer, it is preferred that alkali treatment be performed prior to forming the antistatic layer. By performing the alkali treatment, it is possible to improve adhesion between the coating layer and antistatic layer and also improve scratching resistance of the coating film.

The coating film in accordance with the present invention can be provided on a display surface and, for example, can be provided on the surface of a liquid crystal display device. In this case, the coating film can be used as part of the member of the polarizing plate in the liquid crystal display device. The polarizing plate can be obtained by successively laminating a polarizing layer and a transparent base material on another surface of the coating film in accordance with the present invention where the coating layer has not been provided. A stretched poly(vinyl alcohol) film (PVA) can be used as the polarizing layer, and a film composed of triacetyl cellulose can be used as another transparent base material.

With the coating film in accordance with the present invention, a polarizing plate can be obtained by sandwiching a polarizing layer between the transparent base material of the coating film and another transparent base material. Where the coating film has a large degree of curling, problems are encountered when the polarizing layer is bonded by the coating film and the transparent base material. Because curling is small in the coating film in accordance with the present invention, the occurrence of defects in the bonding process can be prevented.

A liquid crystal display device can be obtained by disposing the polarizing plate containing the coating film in accordance with the present invention opposite another polarizing plate so that the two polarizing plates sandwich a liquid crystal cell and then assembling with a backlight, a diffusion film, a prism sheet, and a brightness increasing film. In this case, the components are so assembled that the coating layer of the coating film in accordance with the present invention becomes the outermost surface layer of the liquid crystal display device. Because the surface of the coating layer in the coating film in accordance with the present invention has a sufficient hardness, the coating layer has a function of protecting the surface of the liquid crystal display device and the surface can be prevented from scratching.

By using the method for manufacturing a coating film in accordance with the present invention, it is possible to manufacture a coating film with a little curling in which the coating layer has a sufficient surface hardness.

In accordance with the present invention, a coating film having a sufficient surface hardness, no wrinkles, and a little curling can be obtained by irradiating the transparent base material with energy of ultraviolet radiation, without heat application, during high-luminance irradiation with ultraviolet radiation.

A xenon flash lamp and a pulsed xenon lamp can be used as means for irradiating with pulsed ultraviolet radiation. Xenon flash lamps and pulsed xenon lamps produce continuous emission from a UV range to an IR (infrared) range, and pulsed light emission with a half-width of about 100 μsec can be obtained. Thus, the coated film can be irradiated with pulsed light by using a xenon flash lamp or a pulsed xenon lamp, and a coating film having a sufficient surface hardness, no wrinkles, and little curling can be obtained by irradiating the transparent base material with energy of ultraviolet radiation, without heat application.

### EXAMPLES

The present invention will be described below in greater detail with reference to examples and comparative examples, but the present invention is not limited to these examples.

### Preparation of Coating Liquid (H-1)

A coating liquid (H-1) was prepared by mixing 100 parts by weight of UV-7605B (manufactured by Nippon Gosei Kagaku Co., Ltd.), 4 parts by weight of Irgacure 184 (manufactured by Ciba Geigy Co.), 50 parts by weight of methyl acetate, and 50 parts by weight of 2-butanone.

### Preparation of Coating Liquid (H-2)

A coating liquid (H-2) was prepared by mixing 100 parts by weight of UN-3320HC (manufactured by Negami Kogyo K.K.), 4 parts by weight of Irgacure 184 (manufactured by Ciba Geigy Co.), 50 parts by weight of methyl acetate, and 50 parts by weight of 2-butanone.

### Example 1

A triacetyl cellulose film with a thickens of 80 μm was used as a transparent base material, and a coating liquid was coated with a bar coater on the triacetyl cellulose film to form a coating film. The coated film on the triacetyl cellulose film was dried to remove the solvent contained in the coated film, and then the coated film was cured by using a pulsed xenon lamp (manufactured by Iwasaki Denki K.K.) to produce a coating film. In this case, as shown in Table 1, the coating liquid (H-1) and coating liquid (H-2) were used as the coating liquid and the coating films of two types that differed in the thickness of the coating layer were produced for each coating liquid. Thus, a total of four types of coating films were produced. Further, the coating films were produced by varying the radiated energy of the pulsed xenon lamp.

TABLE 1

| | | Number of | Film | Pencil | | |
|---|---|---|---|---|---|---|
| Coating | Energy | shots | thickness | hard- | | Adhesive- |
| liquid | (J) | (times) | (μm) | ness | Curling | ness |
| H-1 | 80 | 5 | 10 | 3H | ◯ | 100 |
| H-1 | 120 | 5 | 11 | 3H | ◯ | 100 |
| H-2 | 80 | 5 | 11 | 3H | ◯ | 100 |
| H-2 | 120 | 5 | 12 | 3H | ◯ | 100 |

The coating films obtained were evaluated by the following methods. The evaluation results are shown in Table 1.

Thickness of coating layer: measured with a film thickness meter (model 205-0020; manufactured by FILMETORICS Co.).

Pencil hardness: measured according to JIS K 5400 under a load of 500 g with respect to the coating layer of the coating film.

Curling: evaluated by the rise of the edge of the coating film cut to a size of 10×10 cm. ◯: rise less than 2 cm; A: rise equal to or more than 2 cm; X: rise resulted in tubular shape.

Adhesiveness: checkered cuts (size of one square: 1 mm×1 mm, 10 squares×10 squares=100 squares) were made in the coating layer of the coating film and a peeling test with a cellophane pressure-sensitive adhesive tape was conducted. The numerical value represents the number of remaining squares (100: no peeling of the coated film, 0: all squares are peeled off).

The coating films obtained in Example 1 had a surface hardness of the coating layer of 3H or more, and the evaluation of curling was also good. Thus, in Example 1, coating films could be obtained in which the coating layer had a sufficient surface hardness and the curling was small. Further, the adhesiveness of the transparent base material and hard coat layer was also sufficient.

### Example 2

Coating films were produced in the same manner as in Example 1 by using a xenon flash lamp (manufactured by Ushio Denki KK) instead of the pulsed xenon lamp of Example 1. In this case, as shown in Table 2, the coating liquid (H-1) and coating liquid (H-2) were used as the coating liquid and the coating films of two types that differed in the thickness of the coating layer were produced for each coating liquid. Thus, a total of four types of coating films were produced. Further, the coating films were produced by varying the radiated energy of the xenon flash lamp.

TABLE 2

| | | Number of | Film | Pencil | | |
|---|---|---|---|---|---|---|
| Coating | Energy | shots | thickness | hard- | | Adhesive- |
| liquid | (J) | (times) | (μm) | ness | Curling | ness |
| H-1 | 90 | 7 | 9 | 3H | ◯ | 100 |
| H-1 | 130 | 7 | 11 | 3H | ◯ | 100 |
| H-2 | 90 | 7 | 9 | 3H | ◯ | 100 |
| H-2 | 130 | 7 | 12 | 3H | ◯ | 100 |

The coating films obtained in Example 2 had a surface hardness of the coating layer of 3H or more, and the evaluation of curling was also good. Thus, in Example 2, coating films could be obtained in which the coating layer had a sufficient surface hardness and the curling was small. Further, the adhesiveness of the transparent base material and hard coat layer was also sufficient.

### Comparative Example 1

Coating films were produced in the same manner as in Example 1 by using an ultraviolet irradiation device (manufactured by Iwasaki Denki KK; F600V-10, power 80%, transfer speed 15 m/min) instead of the pulsed xenon lamp of Example 1. In this case, as shown in Table 3, the coating liquid (H-1) and coating liquid (H-2) were used as the coating liquid and the coating films of two types that differed in the thickness of the coating layer were produced for each coating liquid. Thus, a total of four types of coating films were produced. The coating film thickness, pencil hardness, curling, and adhesiveness were evaluated for the obtained coating films in the same manner as in Example 1. The evaluation results are shown in Table 3.

TABLE 3

| | Film thickness | Pencil | | |
|---|---|---|---|---|
| Coating liquid | (μm) | hardness | Curling | Adhesiveness |
| H-1 | 10 | 3H | Δ | 100 |
| H-1 | 11 | 3H | X | 100 |
| H-2 | 11 | 3H | Δ | 100 |
| H-2 | 12 | 3H | X | 100 |

The coating film obtained in Comparative Example 1 had a surface hardness of the coating layer of 3H or more, but the curling evaluation was poor and the coating curled easily.

### (Formation of Antireflective Layer)

In Example 1 an antireflective film was formed on the coating film by the below described method implemented with respect to a coating film having a coating layer with a thickness of 10 μm that was cured by five shots of energy of 80 J with a pulsed xenon lamp by using the coating liquid H-1. The coating film thus obtained was subjected to alkali treatment by dipping for 2 min in a 1.5N-NaOH aqueous solution heated to 50° C., washed with water, neutralized by dipping for 30 sec at room temperature in a 0.5 wt. % aqueous H₂SO₄, washed with water, and dried. On the other hand, silicon alkoxide containing tetramethoxysilane was used as a starting material and hydrolyzed with 1 mol/L hydrochloric acid to obtain an oligomer. A total of 5 parts by weight of the oligomer and 5 parts by welding of silica particles with a low refractive index were diluted with 190 parts by weight of isopropanol to prepare a coating liquid for forming a layer with a low refractive index. The obtained coating liquid for forming a layer with a low refractive index coated with a bar coat on the coating layer subjected to alkali treatment to obtain a dry film thickness of 100 nm. The coating was then dried to obtain an antireflective layer. The obtained coating film in which the antireflective layer was provided on the coating layer had a sufficient surface hardness and little curling, similarly to the coating film before the antireflective layer was formed thereon.

What is claimed is:

1. A method for manufacturing a coating film having a coating layer on a transparent base material, comprising: forming a coated film by applying a coating liquid having a material for forming a coating layer that is curable by ultraviolet radiation on the transparent base material; and
irradiating the coated film comprising the coating liquid and formed on the transparent base material with pulsed ultraviolet radiation to form the coating layer.

2. The method for manufacturing a coating film according to claim 1, wherein
the coating liquid having the material curable with ultraviolet radiation comprises an urethane (meth)acrylate oligomer in an amount of 25 parts by weight or more to 100 parts by weight of less per 100 parts by weight of the material included in the coating liquid.

3. The method for manufacturing a coating film according to claim 1, wherein
a thickness of the coating layer is 5 μm or more to 20 μm or less.

4. The method for manufacturing a coating film according to claim 1, wherein
the transparent base material includes a triacetyl cellulose film.
